(19) United States
(12) Patent Application Publication
(10) Pub. No.: US 2009/0000646 A1
(43) Pub. Date: Jan. 1, 2009

(54) Paint Roller Cover Cleaning Device and Method

(76) Inventors: Donald G. Durant, Tucson, AZ (US); Ronald D. Durant, Tucson, AZ (US)

Correspondence Address: LAWRENCE R. OREMLAND, P.C., 5055 E. BROADWAY BLVD., SUITE C-214, TUCSON, AZ, 85711, US

(21) Appl. No.: 12/143,561

(22) Filed: Jun. 20, 2008

Related U.S. Application Data
(60) Provisional application No. 60/945,683, filed on Jun. 22, 2007.

(51) Int. Cl. B08B 9/027; B08B 13/00; B08B 3/02

(52) U.S. Cl. 134/22.11; 134/33; 134/199; 134/170

(57) ABSTRACT

A new and useful device and method for cleaning a paint roller cover is provided. A paint roller frame has a longitudinal axis, and is supported in a manner such that the frame can spin freely about its longitudinal axis. A paint roller cover is placed on the roller frame, so that the paint roller cover extends about the longitudinal axis of the frame, and can spin with the frame about the longitudinal axis, thereby forming a frame/paint roller cover assembly that has the same longitudinal axis as the frame. A manifold is adapted to be connected to a source of cleaning fluid (e.g. water), and an array of no more than three spray nozzles are supported by the manifold. The array of spray nozzles

(vii) each have predetermined spray angles at which cleaning fluid is directed therefrom, and

(viii) are oriented to direct their sprays of cleaning fluid at the frame/paint roller cover assembly in a direction that is offset from the longitudinal axis of the frame/paint roller cover assembly and at a predetermined distance range from the paint roller cover, such that
a. the spray(s) directed from the nozzles will simultaneously spin and rinse the paint roller cover, and
b. the cleaning fluid directed from the spray nozzles and at the paint roller cover will effectively spin and rinse a 9′ paint roller cover.

### RELATED APPLICATION/CLAIM OF PRIORITY

This application is related to and claims priority from provisional application Ser. No. 60/945,683, filed Jun. 22, 2007, which provisional application is incorporated by reference herein.

### BACKGROUND

The present invention relates to a new and useful device and method for cleaning a paint roller cover.

In the applicants' experience, cleaning a paint roller cover, for latex and water based paints, is a useful objective, because it enables a painter (amateur or professional) to reuse the paint roller cover, rather than having to obtain a new paint roller cover. However, applicants have determined that a paint roller cover cleaning device and method has to be simple, effective at cleaning a paint roller cover, and economical (i.e. affordable to both amateur and professional painters, and make efficient use of the water used to clean the paint roller cover). Also, cleaning a paint roller cover should be environmentally responsible, in the sense that it is designed to collect the cleaning material and the cleaned paint in a way that allows those materials to be disposed of in an environmentally responsible way.

### SUMMARY OF THE INVENTION

The present invention provides a paint roller cleaning device and method that achieves the foregoing objectives. The paint roller cover cleaning device and method of the present invention is simple, effective at cleaning a paint roller cover, and economical to produce and to use.

Moreover, the paint roller cover cleaning device is particularly effective at cleaning a standard 9 inch paint roller cover.

In addition, the cleaning device and method of the present invention is designed to collect the cleaning fluid and cleaned paint in a way that enables those materials to be disposed of in an environmentally responsible way.

According to the present invention, a paint roller frame has a longitudinal axis, and is supported in a manner such that the frame can spin freely about its longitudinal axis. A paint roller cover is placed on the roller frame, so that the paint roller cover extends about the longitudinal axis of the frame, and can spin with the frame about the longitudinal axis, thereby forming a frame/paint roller cover assembly that has the same longitudinal axis as the frame. A manifold is adapted to be connected to a source of cleaning fluid (e.g. water), and an array of no more than three spray nozzles are supported by the manifold. The array of spray nozzles
i) each has a predetermined spray angle at which cleaning fluid is directed therefrom, and
(ii) are oriented to direct their sprays of cleaning fluid at the frame/paint roller cover assembly in a direction that is offset from the longitudinal axis of the frame/paint roller cover assembly and at a predetermined distance range from the paint roller cover, such that
   a. the spray(s) directed from the nozzles causes the frame/paint roller cover assembly to spin rapidly about the longitudinal axis, and simultaneously rinses the paint roller cover, so that a combination of centrifugal force and the cleaning fluid from the sprays simultaneously spins and rinses the paint roller cover, and
   b. the cleaning liquid directed from the spray nozzles and at the paint roller cover will effectively spin and rinse at least a 9″ paint roller cover.

According to a preferred embodiment, the paint roller frame and the spray nozzles are disposed in a spray cavity, the spray nozzles are located at a distance of at least 5.5 inches (and more preferably from 5.5-6.5 inches) from a paint roller cover disposed on the paint roller frame. In addition, the spray nozzles are each configured and oriented to direct a spray of cleaning fluid at the paint roller cover with a spray pattern having a spray angle of about 40 degrees. Still further, the cavity is located in a container, and the container is configured to be disposed and retained in a 5 gallon bucket when the cleaning fluid is being directed at a paint roller cover in the cavity. Also, the container is a light weight, sturdy structure and is configured such that cleaning fluid and paint are drained from the container into the bucket as the paint roller cover is being cleaned.

In the applicant's experience, the cleaning device and method of the present invention can effectively and efficiently clean a 9 inch paint roller cover, often in less than 2 minutes, with no more than 5 gallons of water, and will collect the water/paint that is drained from the container, so that the water/paint can be disposed of in an environmentally responsible way.

Also, the principles of the present invention can be effectively used to produce a device and method that can clean a single paint roller cover, or can simultaneously clean 2 paint roller covers.

Other features of the present invention will become further apparent from the following detailed description and the accompanying drawings.

### BRIEF DESCRIPTION OF THE DRAWING

FIG. 1 is a schematic three dimensional illustration of a device for cleaning a paint roller cover, according to the principles of the present invention, with the top of the device in an open condition, and with portions of a side wall broken away;

FIG. 2 is a schematic exploded view of a paint roller cover being inserted onto a paint roller frame, in a method according to the principles of the present invention;

FIG. 3 is a side view of spray nozzles directing cleaning fluid at a paint roller cover/frame assembly, in a device according to the principles of the present invention;

FIG. 4 is a top view of spray nozzles directing cleaning fluid at a paint roller cover/frame assembly, in a device according to the principles of the present invention; and

FIG. 5 is a bottom view of the cleaning device of FIG. 1.

### DETAILED DESCRIPTION

As discussed above, the present invention relates to a new and useful device and method for cleaning a paint roller cover. In the drawings, and in the following description, one version of a cleaning device and method are shown and described, for cleaning up to 2 paint roller covers, according to the principles of the present invention. However, from that description, the manner in which the principles of the present invention can be used to clean paint roller covers, with other versions of the cleaning device and method, will be apparent to those in the art.

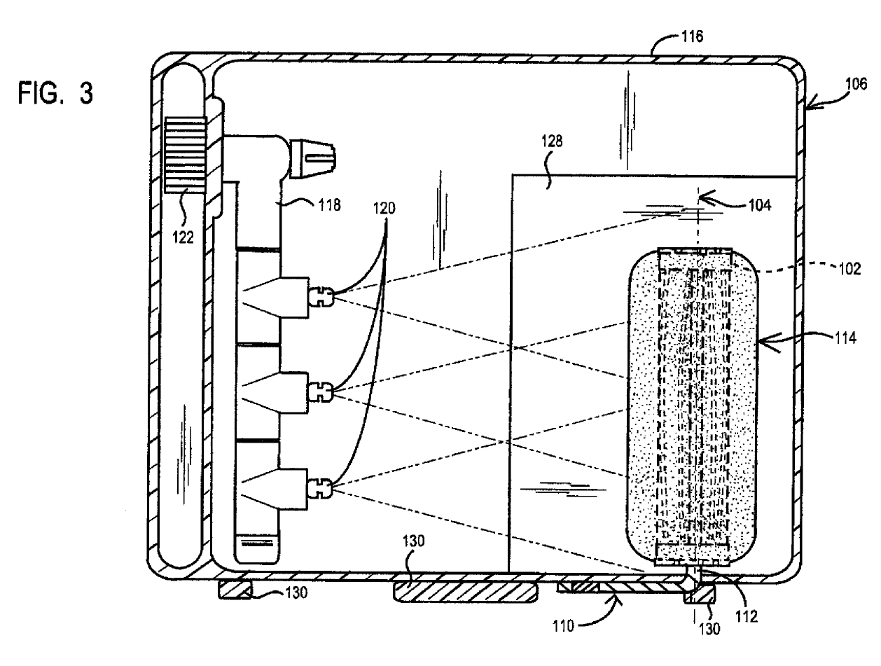

In the Figures a paint roller cover cleaning device 100 is schematically illustrated, that is designed to clean up to 2 paint roller covers. A pair of paint roller frames 102 are provided, each of which has a vertical longitudinal axis 104, and each of which is supported vertically from the bottom of a container 106, in such a manner that each frame can spin freely about its longitudinal vertical axis 104. For example, each of the frames 102 can be a typical paint roller frame that is bolted to the bottom of the container, and has an support arm 110 (FIG. 3) oriented so that its bearing post 112 that rotatably supports the paint roller frame 102 extends vertically from the bottom of the container. The paint roller frame 102 comprises a series of wires 111 extending between a bottom cap 113 and a top cap 115. The paint roller frame 102 extends vertically from the bottom of the container, and can spin freely on the post 112, in substantially the same way that a paint roller frame rotates on its handle support as a paint roller cover on the frame is applying paint to a surface.

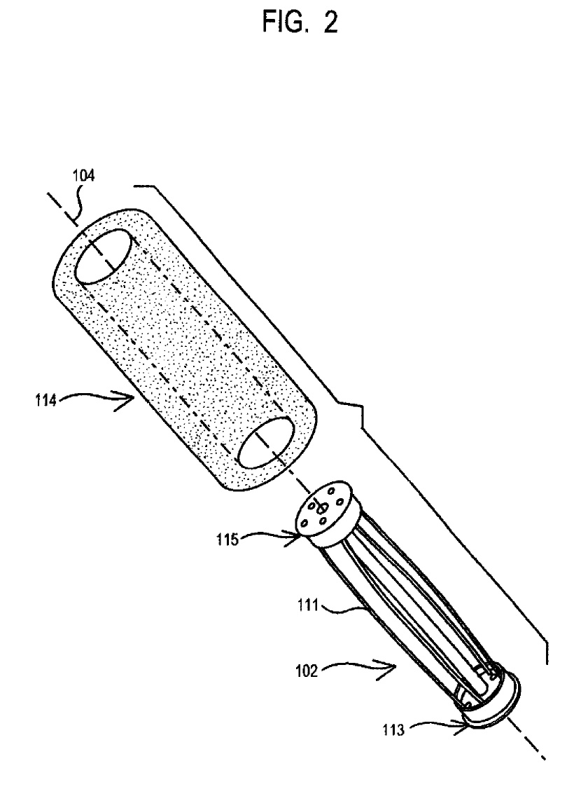

In order to clean a paint roller cover 114, according to the principles of the present invention, the paint roller cover 114 is inserted over the frame 102, so that the paint roller cover and frame form a frame/paint roller cover assembly. In FIG. 2, a paint roller cover 114 is shown as it is being inserted over the frame 102 to form the frame/paint roller cover assembly (which is bracketed in FIG. 2). When the paint roller cover is inserted on the frame 102, the paint roller cover 114, and the frame/paint roller cover assembly extend about the longitudinal axis 104, and can spin freely about the longitudinal axis 104.

A manifold 118 that is associated with each frame/paint roller cover assembly is disposed inside the container 106. Each manifold 118 extends vertically and in spaced relation to a frame/paint roller cover assembly in the container 106. Each manifold 118 has 3 spray nozzles 120 at predetermined locations, which are oriented to direct sprays at the frame/paint roller cover assembly.

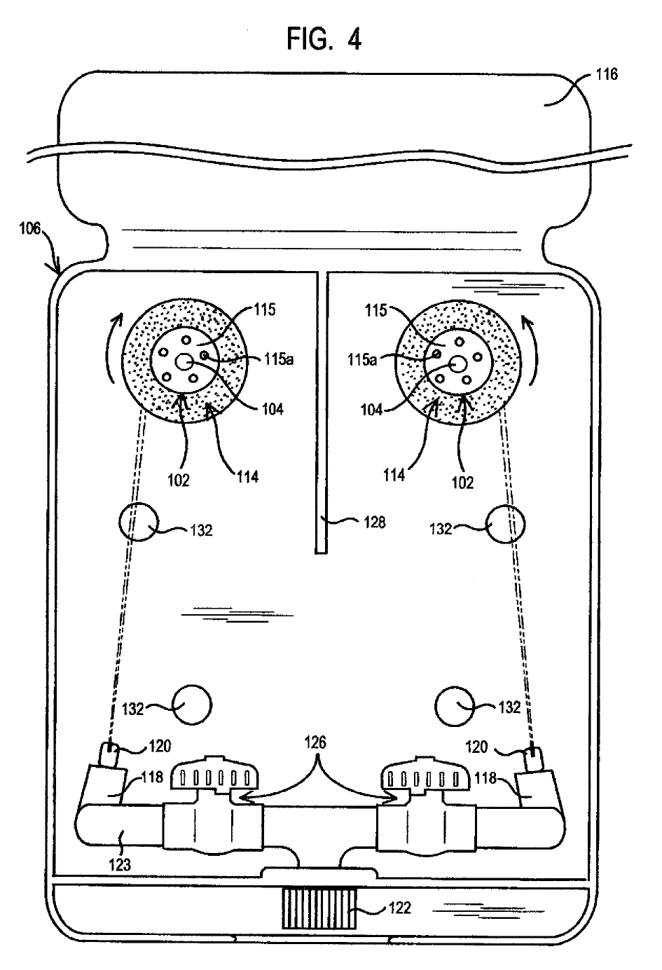

Each spray nozzle 120 is preferably a plastic spray nozzle, made by Spraying Systems Co (Wheaton, Ill.) and distributed under the trademark VeeJet®. Each spray nozzle 120 produces a substantially “flat fan” spray pattern, at a spray angle of about 40 degrees, and at a pressure of about 40 psi. Each manifold 118 is located and oriented such that each of the spray nozzles on the manifold is no closer than 5.5 inches from the frame/paint roller cover assembly, and is preferably located and oriented such that each spray nozzle 120 is located from 5.5 to 6.5 inches from the frame/paint roller cover assembly. Each spray nozzle 120 preferably directs water at the frame/paint roller cover assembly with a spray pattern having a spray angle of about 40 degrees, at a pressure of at least about 40 psi, and a flow rate (determined primarily by the manifold water pressure and the size of the orifice of the spray nozzle) that causes the frame/paint roller cover assembly to spin about the longitudinal axis 104 (in the directions schematically illustrated in FIG. 4) in the manner described herein. Each manifold 118 is connected to a conduit 123 that communicates with a water intake coupling 122, which can be a conventional water source for a home or business, so that water forms the cleaning fluid. The intake coupling 122 can be designed to couple to a conventional garden hose, and can handle water pressures from 40 psi up to 85 psi, which applicants believe is a typical pressure range for urban water systems. Also, it should be noted that the preferred spray nozzles are considered by the applicants to be “state of the art” nozzles, because each spray nozzle has a predetermined spray pattern and a flow rate that optimizes the cleaning action described herein, while also conserving water. However, as the “state of the art” in spray nozzles changes, in regard to providing spray nozzles that can optimize the cleaning effect described herein while also conserving water, other spray nozzles may also be useful in practicing the present invention.

In the embodiment shown in the figures, the container 106 has two frames 102, each of which can support a paint roller cover 114 to form a frame/paint roller cover assembly, and a manifold 118 with an array of spray nozzles 120 is associated with each frame/paint roller cover assembly. The conduit 123 communicates water from the intake 122 to each of the manifolds 118. Also, the water flow in the conduit 123 can be controlled by a pair of shut off valves 126, which are manually operated, so that water from the intake can be communicated to either or both of the manifolds. A partition 128, with a height that extends above the frame/paint roller cover assemblies, separates the frame/paint roller cover assemblies in the container 106 into cleaning sections, and prevents overspray between the cleaning sections of the container 106.

The principles, by which a paint roller cover can be cleaned, according to the present invention, are demonstrated by FIGS. 3 and 4. When a paint roller cover 114 is inserted onto a frame 102, it forms a frame/paint roller cover assembly that extends vertically from the bottom of the container (FIG. 3), and the array of spray nozzles 120 are oriented such that their substantially flat fan sprays are directed at the frame/paint roller cover assembly in a direction that is offset from the longitudinal axis 104 (FIG. 4), and each spray nozzle has the 40 degree angle and is located at the preferred distance of 5.5 to 6.5 inches from the frame/paint roller cover assembly (FIGS. 3 and 4). With a conventional source of water, the water spray from the nozzles is powerful enough to spin the frame/paint roller cover assembly at a high velocity (e.g. at least 2500 rpm), so that centrifugal force and the effect of the water spray cleans paint from the paint roller cover as the frame/paint roller cover assembly is spinning about the longitudinal axis. Also, the top cap 115 of the frame has a series of holes 115a, which enable cleaning water that is sprayed at a frame/paint roller cover assembly to flow into and through the interior of a paint roller cover 114 disposed on the frame 102, thereby rinsing the inside surface of the cover 114 to further clean the cover. The use of three spray nozzles along the manifold spaced apart by about 2.5 inches, and with the lower spray nozzles about 2.5 inches from the bottom of the container, is sufficient to cover and clean at least a 9 inch paint roller cover 114 that is supported on the frame 102.

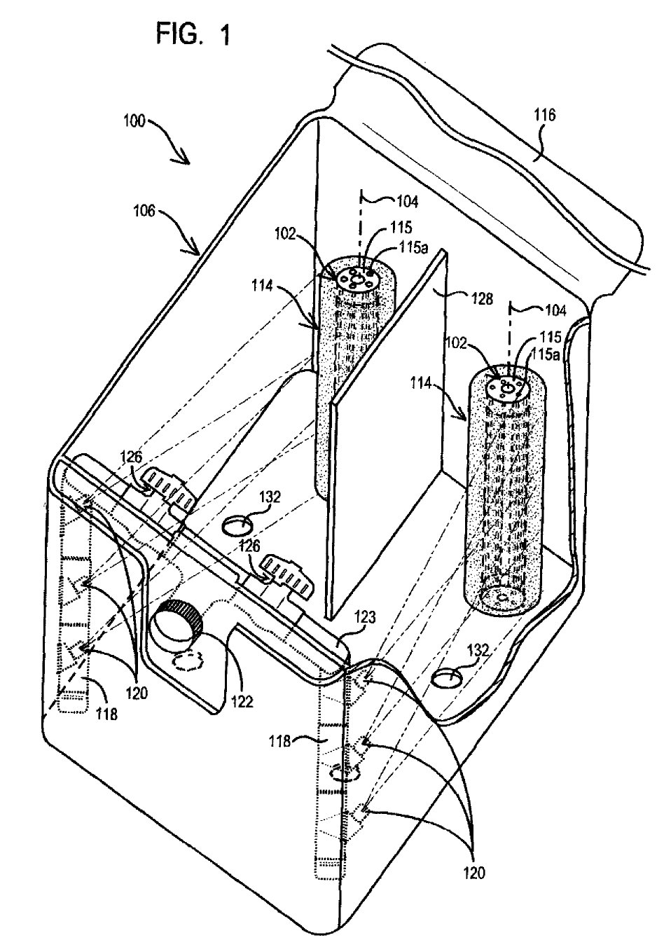

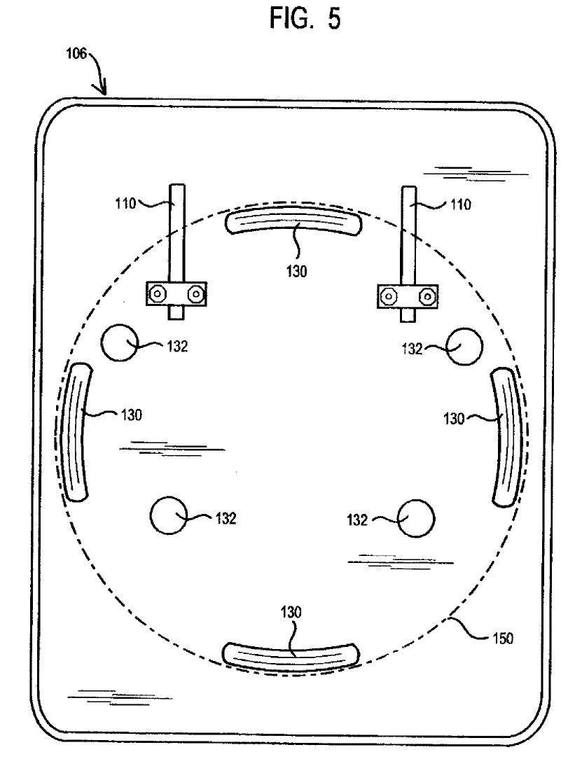

In addition, the device and method of the invention is designed to capture the water/paint from the cleaning process in a manner that the water/paint can be disposed of in an environmentally responsible manner. Specifically, the container has up to four legs 130 at its bottom, which are configured such that when the container 106 is placed in a standard 5 gallon bucket, the legs 130 will press tightly against the wall of the bucket, and maintain the container in a stable position on the bucket. In FIG. 5, the wall of a standard 5 gallon bucket is shown in phantom at 150, and the orientation of the legs 130 relative to the walls of the bucket are also schematically illustrated. The container 120 has a series of drainage holes 132 that allow water and paint from the cleaning process to drain into the bucket, thereby enabling the water and paint from the cleaning process to be disposed of in an environmentally responsible way. The container 106 has a cover 116 that can be pivoted from a position where the interior of the container is uncovered and accessible (FIGS. 1 and 4) to a position where the interior of the container is covered (FIG. 3), so that the cleaning fluid is confined within the container.

The foregoing description exemplifies the principles of the present invention, as they are applied to a container that has 2 paint roller frames, and 2 associated manifolds, each with a set of 3 spray nozzles. Such a container can handle simultaneous cleaning of 2 paint roller covers. A container with such a design can be constructed as a box shaped container that is approximately 13½″ wide, 14″ long and 11½″ high. However, it is contemplated that the principles of the invention can be practiced with a container that has a single paint roller frame, and a single manifold with a set of 3 spray nozzles that are configured similarly to the two paint roller frame version, and oriented in a similar manner to the manifold and nozzles of a 2 paint roller frame version. The difference between the single paint roller frame version and the 2 paint roller frame version is that the box shaped container for the single paint roller frame would have a width of approximately 8½″, rather than 13½″, but its overall dimensions would otherwise be the same.

Also, applicants note that the manual controls for the shut off valves 126 can be manipulated in ways that may control the water pressure in the manifold that is directing water to an array of spray nozzles, to thereby provide some additional control over the pressure and the amount of water that is used during a cleaning operation. Moreover, while the manual controls for the shut off valves are shown in FIGS. 1 and 4 as located on the interior of the container, it is contemplated that such controls may be reoriented, so that they are accessible from the outside of the container (and while the container is closed), to control the water flow to the manifolds.

With the foregoing disclosure in mind, it is believed that various structures and methods of cleaning a paint roller cover, according to the principles of the present invention, will be apparent to those in the art.

1. A method of cleaning a paint roller cover that is at least 9 inches in length, comprising
providing a paint roller frame that has a longitudinal axis,
supporting the paint roller frame in a manner that the frame can spin freely about its longitudinal axis,
locating the paint roller cover on the roller frame, so that the paint roller cover extends about the longitudinal axis of the frame, and can spin with the frame about the longitudinal axis, thereby forming a frame/paint roller cover assembly that has the same longitudinal axis as the frame,
providing a manifold connected to a source of cleaning fluid,
positioning an array of no more than three spray nozzles in fluid communication with the manifold, the array of spray nozzles
(iii) each having predetermined spray angles at which cleaning fluid is directed therefrom, and
(iv) are oriented to direct their sprays of cleaning fluid at the frame/paint roller cover assembly in a direction that is offset from the longitudinal axis of the frame/paint roller cover assembly and at a predetermined distance range from the paint roller cover, such that
a. the spray(s) directed from the nozzles will simultaneously spin and rinse the paint roller cover, and
b. the cleaning fluid directed from the spray nozzles and at the paint roller cover will effectively spin and rinse a 9′ paint roller cover, and
directing cleaning fluid from the array of spray nozzles at the frame/paint roller cover assembly.

2. A method as set forth in claim 1, wherein the paint roller frame and the spray nozzles are disposed in a spray cavity.

3. A method as set forth in claim 2, wherein the spray nozzles are located at a distance of at least 5.5 inches from a paint roller cover disposed on the paint roller frame.

4. A method as set forth in claim 3, wherein the spray nozzles are each configured and oriented to direct a spray of cleaning fluid at a paint roller cover at an angle of about 40 degrees.

5. A method as set forth in claim 1, wherein a pair of paint roller frames are provided, and a set of spray nozzles is provided for each pair of paint roller frames.

6. A method as set forth in claim 1, wherein the cavity is disposed in a container, the container is located and retained in a 5 gallon bucket when the cleaning fluid is being directed at a paint roller cover in the cavity, and cleaning fluid and paint are drained from the container into the bucket as the paint roller cover is being cleaned.

7. A method as set forth in claim 1, wherein the paint roller frame and the orientation of the spray nozzles are configured to direct a flow of cleaning fluid through the interior of the frame, thereby to rinse the inside of a paint roller cover disposed on the frame.

8. Paint roller cover cleaning device, comprising
a paint roller frame that has a longitudinal axis,
the paint roller frame being supported in a manner that the frame can spin freely about its longitudinal axis,
the paint roller frame configured to receive a paint roller cover that is at least 9 inches long, in a manner such that the paint roller cover extends about the longitudinal axis of the frame, and can spin with the frame about the longitudinal axis,
a manifold adapted for connection to a source of cleaning fluid,
the manifold supporting an array of up to three spray nozzles in fluid communication with the manifold, the array of spray nozzles
(v) each having predetermined spray angles at which cleaning fluid is directed therefrom, and
(vi) are oriented to direct their sprays of cleaning fluid at the paint roller cover supported on the frame in a direction that is offset from the longitudinal axis of the frame and at a predetermined distance range from the paint roller cover, such that
a. the spray(s) directed from the nozzles will simultaneously spin and rinse the paint roller cover, and
b. cleaning fluid directed from the spray nozzles and at the paint roller cover will effectively spin and rinse at least a 9′ paint roller cover.

9. The device set forth in claim 8, wherein the paint roller frame and the spray nozzles are disposed in a spray cavity.

10. The device set forth in claim 9, wherein the spray nozzles are located at a distance of at least 5.5 inches from a paint roller cover disposed on the paint roller frame.

11. The device set forth in claim 10, wherein the spray nozzles are configured and oriented so that each directs a spray of cleaning fluid at a paint roller cover at an angle of about 40 degrees.

12. The device set forth in claim 8, wherein a pair of paint roller frames are provided, and a set of spray nozzles is provided for each pair of paint roller frames.

13. The device set forth in claim 8, wherein the spray cavity is located in a container that is configured to be received and retained in a 5 gallon bucket, and to drain cleaning fluid and paint into the bucket.

14. The device set forth in claim 8, wherein the paint roller frame and the orientation of the spray nozzles are configured to direct a flow of cleaning fluid through the interior of the frame, thereby to rinse the inside of a paint roller cover disposed on the frame.
